(19) United States
(12) Patent Application Publication
(10) Pub. No.: US 2026/0119806 A1
(43) Pub. Date: Apr. 30, 2026

(54) METHOD AND APPARATUS FOR GENERATING DEBATE INFORMATION BASED ON A LANGUAGE MODEL, DEVICE AND STORAGE MEDIUM

(71) Applicant: Daoyuan CHI, Beijing (CN)

(72) Inventor: Daoyuan CHI, Beijing (CN)

(21) Appl. No.: 18/937,694

(22) Filed: Nov. 5, 2024

(30) Foreign Application Priority Data
Oct. 25, 2024 (CN) 202411503198.5

(51) Int. Cl. G06F 40/35

(52) U.S. Cl. CPC G06F 40/35

(57) ABSTRACT

A method and an apparatus for generating debate information based on a language model, a device and a storage medium are provided according to the present disclosure, which relate to the technical field of AI. The mood expression capability of the debate information is enhanced through the predetermined language model, so that the output debate information has mood enhancement characteristics of the debate stages in expression, more emotions are given to the debate information to a certain extent, and the mood tension of the debate information in a real debate scene is further improved. The method comprises: receiving an operation instruction for generating debate information of a user, wherein the operation instruction carries topic information input by the user; and generating the debate information with mood enhancement characteristics of debate stages corresponding to the topic information based on a predetermined language model and the topic information.

### CROSS-REFERENCE TO RELATED APPLICATIONS

The application claims priority to Chinese patent application No. 202411503198.5, filed on Oct. 25, 2024, the entire contents of which are incorporated herein by reference.

### TECHNICAL FIELD

The present disclosure relates to the field of AI (artificial intelligence) technology, and in particular to a method and an apparatus for generating debate information based on a language model, a device and a storage medium.

### BACKGROUND

In the field of AI, a language model, based on deep learning and a large amount of training data, can support various complex language generation and interaction modes. By taking the application of the debate scene as an example, the large language model in the debate scene can help the both debate sides to better understand the topic and find the argument, thereby outputting the debate information with higher quality and persuasion. However, in real debates, the debate result is not only determined by the statement of viewpoint, but also by emotions, tone and communication skills. The debate result may be directly influenced by the complex emotion change and the excellent communication skill. The debate information output by the existing large language models is only a statement of viewpoint, and is usually expressed in a rather mechanical manner, which lacks of mood tension of a real debate scene, and is difficult to excite mood resonance or real thinking challenges.

### SUMMARY

In view of this, a method, an apparatus for generating debate information based on a language model, a device and a storage medium are provided according to the present disclosure, aiming to solve the problems that the debate information output by a large language model in the prior art is usually a statement of viewpoint, and is usually expressed in a rather mechanical manner and is difficult to excite mood resonance or real thinking challenges.

According to a first aspect of the present disclosure, a method for generating debate information based on a language model is provided. The method includes:
receiving an operation instruction for generating debate information of a user, wherein the operation instruction carries topic information input by the user, and wherein the type of the topic information includes any one or more of the following: text, audio and picture; and
generating the debate information with mood enhancement characteristics of debate stages corresponding to the topic information based on a predetermined language model and the topic information.

According to a second aspect of the present disclosure, an apparatus for generating debate information based on a language model is provided. The apparatus includes:
a receiving unit configured to receive an operation instruction for generating debate information of a user, wherein the operation instruction carries topic information input by the user, and wherein the type of the topic information comprises any one or more of the following: text, audio and picture; and
a generation unit configured to generate the debate information with mood enhancement characteristics of debate stages corresponding to the topic information based on a predetermined language model and the topic information.

According to a third aspect of the present disclosure, a computer device is provided. The computer device includes: a memory storing a computer program; and a processor, wherein the processor, when executing the computer program, performs the steps of the method according to the first aspect.

According to a fourth aspect of the present disclosure, a readable storage medium is provided. The readable storage medium stores a computer program, wherein the computer program, when executed by a processor, performs the steps of the method according to the first aspect.

By means of the above technical solutions, a method and an apparatus for generating debate information based on a language model are provided according to the present disclosure. In the present disclosure, in comparison with the method for generating the debate information based on a large language model in the prior art, an operation instruction for generating debate information of a user is received. The operation instruction carries topic information input by the user. The type of the topic information includes any one or more of the following: text, audio and picture. The debate information with mood enhancement characteristics of debate stages corresponding to the topic information is generated based on a predetermined language model and the topic information. The mood expression capability of the debate information is enhanced through the predetermined language model in the whole process, so that the output debate information has mood enhancement characteristics of the debate stages in expression, more emotions are given to the debate information to a certain extent, and the mood tension of the debate information in a real debate scene is further improved.

The above description is merely an overview of the technical solutions of the present disclosure. Embodiments of the present disclosure are described hereinafter in order for a clear understanding of the technical solutions of the present disclosure so as to implement the technical solutions based on the specification, and further for a clear and easy understanding of the above and other objectives, features and advantages of the present disclosure.

### BRIEF DESCRIPTION OF DRAWINGS

The accompanying drawings described herein are used for providing a further understanding of the present disclosure, and form a part of the present disclosure. Exemplary embodiments of the present disclosure and descriptions thereof are for explaining the present disclosure, and do not constitute any inappropriate limitation to the present disclosure. In the accompanying drawings:

FIG. 1 is a flowchart of a method for generating debate information based on a language model according to an embodiment of the present disclosure;

FIG. 2 is a flowchart of a method for generating debate information based on a language model according to another embodiment of the present disclosure;

FIG. 3 is a flowchart of a method for generating debate information based on a language model according to another embodiment of the present disclosure;

FIG. 4 is an application scenario of a method for generating debate information based on a language model according to an embodiment of the present disclosure;

FIG. 5 is a flow block diagram of a method for generating debate information based on a language model according to another embodiment of the present disclosure;

FIG. 6 is a schematic structural diagram of an apparatus for generating debate information based on a language model according to an embodiment of the present disclosure;

FIG. 7 is a schematic structural diagram of a computer device according to an embodiment of the present disclosure.

### DETAILED DESCRIPTION OF THE EMBODIMENTS

The contents of the present disclosure will now be described with reference to exemplary embodiments. It should be understood that these embodiments are described only to enable those skill in the art to better understand and thus implement the present disclosure, and are not meant to imply any limitations on the scope of the present disclosure.

As used herein, the term “including” and its variants are to be read as open-ended terms meaning “including, but not limited to”. The term “based on” is to be read as “at least based on”. The terms “one embodiment” and “an embodiment” are to be read as “at least one embodiment”. The term “another embodiment” is to be read as “at least one other embodiment”.

In the related art, the debate information output by the large language model is only a statement of viewpoint, and is usually expressed in a rather mechanical manner, which lacks of mood tension of a real debate scene, and is difficult to excite mood resonance or real thinking challenges.

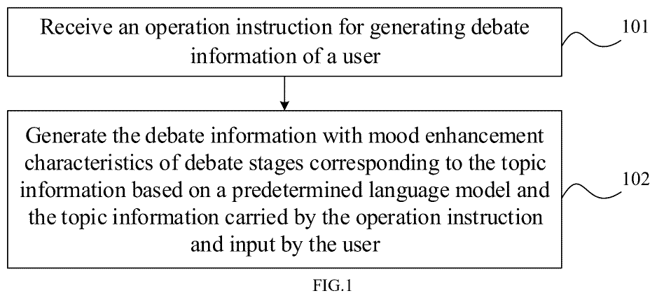

In order to solve this problem, a method for generating debate information based on a language model according to an embodiment of the present disclosure is provided. As shown in FIG. 1, the method includes steps 101 and 102.

In step 101, an operation instruction for generating debate information of a user is received.

In the embodiment, the debate scene will usually provide topic information. The operation instruction carries topic information input by the user. The type of the topic information includes any one or more of the following: text, audio and picture. In terms of the text-type topic information, the topic information input by the user may be a piece of text. In terms of the audio-type topic information, the topic information input by the user may be a section of speech. In terms of the picture-type topic information, the topic information input by the user may be text topic information recognized by AI, or may be topic information that AI understands the image may correspond to.

Correspondingly, the information for debating output based on the topic information is equivalent to the debate information. The debate information includes the debate information output at debate stages. For example, the debate information may be an affirmative and negative viewpoint in a viewpoint output stage. The debate information may be an affirmative and negative opening statement in the opening statement stage. The debate information may be an affirmative and negative rebuttal speech in the rebuttal speech stage. The debate information may be an affirmative and negative free debate in the free debate stage. The debate information may an affirmative and negative closing statement in the closing statement stage. For example, if the topic information input by the user is “In the era of big data, our lives become more relaxed/heavier”, the debate information generated by debate based on the topic information includes the affirmative and negative viewpoints, that is, “In the era of big data, our lives become more relaxed” and “In the era of big data, our lives become heavier”. It should be understood that the debate information may be generated only from any one of the affirmative and negative viewpoints, or may be generated from both viewpoints, which is not limited in the embodiment of the present disclosure.

In step 102, the debate information with mood enhancement characteristics of debate stages corresponding to the topic information is generated based on a predetermined language model and the topic information carried by the operation instruction and input by the user.

The debate information includes any one or more of the following: text, speech, video, picture, virtual object with real-time interaction function. In terms of the text-type debate information, the generated debate information is a piece of text. In terms of the audio-type debate information, the generated debate information is a section of speech, wherein the speech may be generated directly through the predetermined language model, or may be audio generated from text to speech (TTS) based on the text-type debate information. In terms of the debate information combining text and speech, the generated topic information is a speech segment with a text description. Here, the virtual object with a real-time interaction function may be a digital human with the real-time interaction function. The complete expression of the debater in a real debate scene may be simulated by showing one or more following characteristics of the digital human: mouth shape, facial expression, language, tone, body movement and the like, so that the debate information is vividly presented, and the presentation effect has more infectivity and expression tension. The interaction driving data of the digital human may be directly output based on a multi-mode large language model, and may also be rendered in real-time by a digital human rendering engine according to digital human rendering driving parameters corresponding to debate information output by the predetermined language model. The digital human rendering driving parameters may be generated based on the debate information through a pre-trained AI model. The rendering result is audio and video interaction presentation of the digital human associated with the debate information. The debate information output by the virtual object with a real-time interaction function shows the mood enhancement characteristics in debate stages. For example, the debate information output by the virtual object with a real-time interaction function shows the self-confident mood enhancement characteristic in the opening statement stage. The debate information output by the virtual object with a real-time interaction function shows the professional mood enhancement characteristic in the closing statement stage.

In an embodiment, the debate information includes a virtual object with a real-time interaction function. Specifically, the debate information corresponding to the topic information is presented through the virtual object with a real-time interaction function. The debate information is generated based on a predetermined language model and the topic information, and has mood enhancement characteristics of debate stages.

In the embodiment, the predetermined language model is a basic language model adjusted by mood enhancement. The basic language model may be a general language model or a language model specially trained for a debate scene, which is not limited herein. Particularly, the mood enhancement adjustment is a mood enhancement adjustment by a prompt and/or a mood enhancement adjustment by a model fine-tuning. Specifically, the process of the mood enhancement adjustment by a prompt mainly includes: setting prompts in the debate stages; and training the basic language model with the prompts to enhance mood expression in the debate stages. The process of the mood enhancement adjustment by a model fine-tuning mainly includes: identifying mood labels of the debate stages; and fine-tuning the basic language model with the mood labels to enhance mood expression in the debate stages.

Considering the difference of the types of the topic information, the topic information input by the user on the website may be the type of information which cannot be recognized by the predetermined language model. In order to generate more accurate topic information, the information type of the topic information may be preprocessed before the topic information is input into the predetermined language model, so that the topic information is converted into the type of information which can be recognized by the predetermined language model. In an implementable scene, if the predetermined language model may identify the topic information of the text type, the topic information is type-converted to text-type topic information and input into the predetermined language model. For example, for the picture-type topic information, the text information in the picture may be acquired through a text recognition technology and input into the predetermined language model as the text-type topic information. Similarly, for the audio-type topic information, the text information in the audio may be acquired through a speech recognition technology and input into the predetermined language model as the text-type topic information.

Certainly, if the predetermined language model has the information type conversion function, the topic information of different information types may also be directly input into the predetermined language model, so that the debate information of corresponding type requirements may be output by the predetermined language model according to the type requirements of the debate information. At this moment, independent of the type of the topic information, the type of the output debate information may be generated according to the requirements of the user. For example, in terms of the picture-type topic information, the type of the debate information may be selected as the audio type by the user. The debate information of the audio type may be correspondingly output by inputting the topic information of the picture type into the predetermined language model.

It should be noted that the above information types may be one or more of the following: text, picture and audio. The topic information and/or debate information of the corresponding information types may be delivered to a client in one or more of the following manners: page presentation, voice playing and virtual object interaction. The text type of topic information and/or debate information may be transmitted to a client by way of page presentation. The picture type of topic information and/or debate information may be transmitted to a client by way of page presentation. The audio type of topic information and/or debate information may be transmitted to a client by way of voice playing and/or virtual object interaction.

Further, in order to enhance the mood expression of the debate information in the debate stages, the debate information is preferably transmitted to the client by way of voice playing and/or virtual object interaction. Since speeches and virtual models can more realistically reflect mood fluctuations and interactions than text, the emotion enhancement characteristics of the debate information may be more easily reflected through voice playing and/or virtual interaction object, thereby improving the emotion expression effect of the debate information in the debate stages.

A method for generating debate information based on a language model is provided according to the present disclosure. In the present disclosure. In comparison with the method for generating the debate information based on a large language model in the prior art, an operation instruction for generating debate information of a user is received. The debate information with mood enhancement characteristics of debate stages corresponding to the topic information is generated based on a predetermined language model and the topic information carried by the operation instruction and input by the user. Here, the type of the topic information includes any one or more of the following: text, audio and picture. The mood expression capability of the debate information is enhanced through the predetermined language model in the whole process, so that the output debate information has mood enhancement characteristics of the debate stages in expression, more emotions are given to the debate information to a certain extent, and the mood tension of the debate information in a real debate scene is further improved.

In application scenarios, the debate stages include any one or more of the following: opening statement stage, rebuttal speech stage, free debate stage and closing statement stage. The debate stages correspond to different mood enhancement characteristics. The correspondence between the mood enhancement characteristics of the debate stages includes one or more of the following characteristics: tone, manner, expression manner, reference and logical structure. It should be understood that debate stages have a debate sequence in a debate scene. Generally, the debate sequence is: opening statement stage, rebuttal speech stage, free debate stage and closing statement stage. If the debate stages include the opening statement stage, debate information with mood enhancement characteristics of the opening statement stage corresponding to the topic information may be generated correspondingly based on the predetermined language model and the topic information. If the debate stages include the opening statement stage and the rebuttal speech stage, debate information with mood enhancement characteristics of the opening statement stage and the rebuttal speech stage corresponding to the topic information may be generated correspondingly based on the predetermined language model and the topic information.

It should be noted that the debate information in the debate scene is generated based on the debate sequence between the both sides. That is, in the case that the debate information of one side in the current debate stage is known, the debate information of the other side in the current debate stage may be generated based on the debate sequence. It is not possible to skip the debate stage or generate debate information multiple times by one side. For example, in the case that affirmative's debate information of the rebuttal speech stage is known, negative's debate information of the rebuttal speech stage may be generated based on the affirmative's debate information of the rebuttal speech stage. At this time, the debate information after the rebuttal speech stage cannot be generated unless the opening statement stage is finished.

In the embodiment, the correspondence between the mood enhancement characteristics of the debate stages includes any one or more of the following:

the opening statement stage corresponds to a first mood enhancement characteristic, and correspondingly, the debate information corresponding to the topic information comprises one or more of the following characteristics: clear debate viewpoint, clear logical relationship and self-confident tone. That is, the opening statement stage requires clear rules, clear viewpoints, and the debate information expresses the debater's confidence. Correspondingly, the examples of the debate information of the opening statement stage output by the predetermined language model are as follows: “Dear judges and opponents, hello! We firmly believe that AI can improve people's employment experience. First of all, with the popularization of AI, repetitive and mechanical work will be replaced, people can be freed from tedious labor and devote themselves to more creative and valuable work. Secondly, AI has brought us new employment opportunities, such as data analysts, AI trainers, etc., which expands the employment market. In summary, AI will not only not reduce employment, but will improve people's employment experience.”

The rebuttal speech stage corresponds to a second mood enhancement characteristic, and correspondingly, the debate information corresponding to the topic information comprises any one or more of the following characteristics: a strong tone and a set mood expression manner. The mood expression manner comprises any one or more of the following: parallelism, contrast and rhetorical questions. That is, the rebuttal speech stage requires a strong tone, using parallelism, contrast, rhetorical questions, etc. to enhance momentum. Correspondingly, the examples of the debate information of the rebuttal speech stage output by the predetermined language model are as follows: “Dear opponent, do you think humans are only suitable for repetitive and mechanical work? Shouldn't we be happy that AI has replaced boring labor? Instead of being bound by work, we should pursue innovation and wisdom! AI has brought new jobs, new skills, and new possibilities. Why should we turn a blind eye to it? Are we going to refuse to make progress and stagnate?”

The free debate stage corresponds to a third mood enhancement characteristic, and correspondingly, the debate information corresponding to the topic information comprises a set speech expression manner, wherein the speech expression manner comprises a lifelike example manner and/or a spoken language expression manner. That is, the free debate stage requires spoken language expression and lifelike example to make people understand and empathize better. Correspondingly, the examples of the debate information of the free debate stage output by the predetermined language model are as follows: “Think about it, are there any examples around us where work has become easier because of the emergence of AI? For example, doctors use AI to assist in diagnosis and find diseases faster and more accurately; teachers use smart education platforms to teach more targeted. Many people have also found high-paying jobs by learning AI-related skills. Isn't it because of AI that everyone's employment experience has become better?”

The closing statement stage corresponds to a fourth mood enhancement characteristic, and correspondingly, the debate information corresponding to the topic information comprises a reference characteristic of a set field to provide professional debate support. The reference characteristic comprises text cite and/or key data reference. The set field is a field associated with the topic information. That is, the closing statement stage requires the use of key data, well known as classical quotes to enhance expertise. Correspondingly, the examples of the debate information of the rebuttal speech stage output by the predetermined language model are as follows: “As shown in the 2020 Future of Jobs Report, AI will create nearly 60 million new jobs in the next five years. At the same time, Microsoft CEO Satya Nadella once said: “AI is not replacing humans, but enhancing human capabilities.” Data and authoritative opinions have proven that AI is actively changing the employment market and improving people's employment experience. We should follow the trend and embrace the future!”

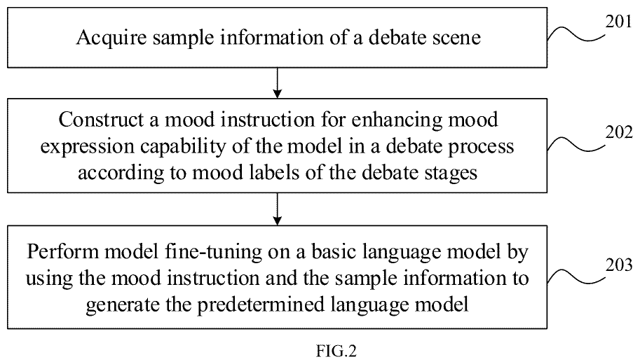

In application scenarios, in consideration of the training process of the predetermined language model, as shown in FIG. 2, before step 101, the method further includes steps 201 to 203.

In step 201, sample information of a debate scene is acquired.

In step 202, a mood instruction for enhancing mood expression capability of the model in a debate process is constructed according to mood labels of the debate stages.

In step 203, model fine-tuning is performed on a basic language model by using the mood instruction and the sample information to generate the predetermined language model.

The sample information comprises topic sample information and debate sample information of the debate stages corresponding to the topic sample information. Here, the debate sample information may be the debate content provided by a debate competition in a debate scene and may also be the debate content generated based on a model.

Specifically, the sample information of the debate scene is debate information generated by arguing at each debate stage based on the provision of the topic information. Since the debaters are interactive, the debate information is also recorded in an interactive manner. That is, in each stage of the debate, after one side provides the debate information, the other side provides the debate information, until the current debate stage ends and the next debate stage begins, the two sides continue to perform the interaction of the debate information.

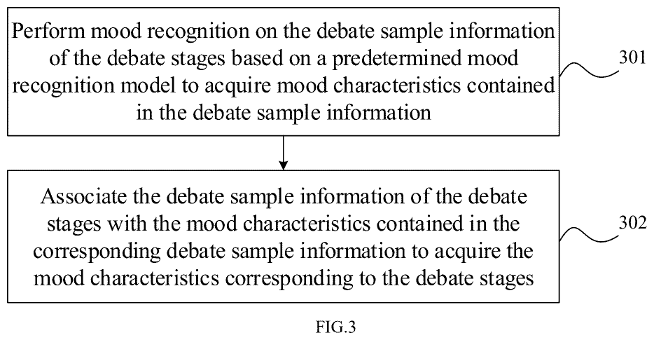

Considering the mood fluctuation of the debate information in the real debate scene, the debate sample information of the debate stages usually has different mood expressions. As shown in FIG. 3, after step 201, the method further includes steps 301 and 302.

In step 301, mood recognition is performed on the debate sample information of the debate stages based on a predetermined mood recognition model to acquire mood characteristics contained in the debate sample information.

In step 302, the debate sample information of the debate stages is associated with the mood characteristics contained in the corresponding debate sample information to acquire the mood characteristics corresponding to the debate stages.

In the embodiment, the mood characteristics contained in the debate stages may be reflected through the text structure and tone with mood expressions. For the same mood characteristics, different text structures may change the mood expression of the argumentative information. For example, parallelism may emphasize the momentum of the argumentative information, and interrogative sentences may emphasize the uncertainty of the topic information. For the same mood characteristics, different voices/intonations will change the mood expression of the debate information. For example, a rhetorical question may emphasize the momentum of the argumentative information, and an exclamatory tone may emphasize the emotional expression of the argumentative information. Specifically, mood recognition may be performed on the debate sample information of the debate stages through a predetermined mood recognition model on the basis of the text structure and tone contained in the debate sample information to acquire mood characteristics contained in the debate sample information. The mood characteristics contained in the debate sample information may be accurately recognized and acquired for target debate sample information containing the text structure and tone with mood expression.

It can be understood that, in order to make the predetermined language model have the mood expression capability in a real debate scene, the debate sample information is marked according to the corresponding mood characteristics of the debate stages. The debate sample information of the debate stages may be associated with the mood characteristics contained in the corresponding debate sample information.

Specifically, after the debate sample information of the debate stages is associated with the mood characteristics contained in the corresponding debate sample information, the mood characteristics corresponding to the debate stages may be described through a mood mapping table. The mood mapping table may be in the following form.

The opening statement stage corresponds to mood characteristics of confidence (clear rules and clear viewpoints).

The rebuttal speech stage corresponds to mood characteristics of excitement and stimulation (a strong tone, using parallelism, contrast, rhetorical questions, etc. to enhance momentum).

The free debate corresponds to mood characteristics of empathy (spoken language expression and lifelike example to make people understand and empathize better).

The closing statement stage corresponds to mood characteristics of expertise (the use of key data, well known as classical quotes to enhance expertise and make it more convincing).

In application scenarios, the method for generating debate information based on a language model may be applied to a debate platform. On the basis of topic information input by a user, the debate platform may generate a debate generation task according to the topic information. The debate generation task is disassembled and iteratively analyzed according to a debate time sequence through a predetermined language model to generate debate information of multiple rounds. The debate information of each round has interactivity, and rebutting may be carried out based on the debate information of the previous round.

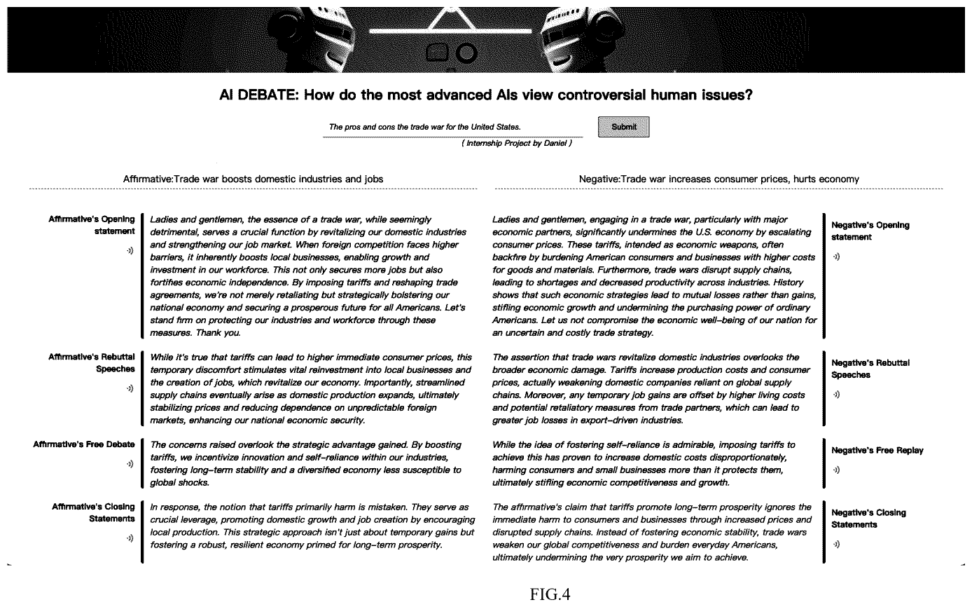

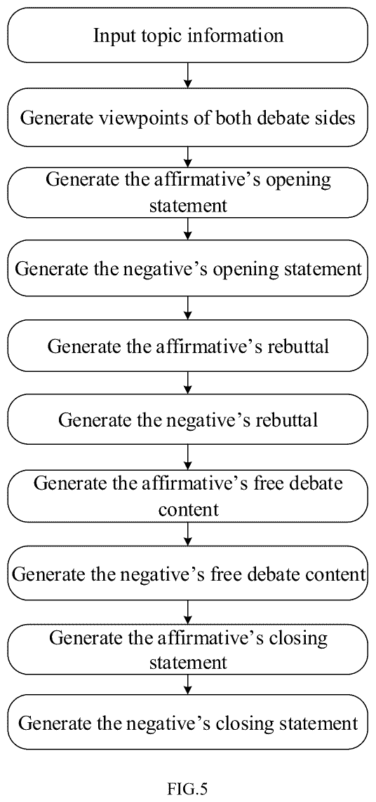

In application scenarios, the operation instruction for the user to generate the debate information may be triggered through a website behavior. For example, after the user uploads the topic information to the website, the operation instruction for the user to generate the debate information is triggered through a click behavior, or may be automatically triggered through the background server. For example, after the user uploads the topic information to the website, the background server automatically triggers the operation instruction for the user to generate the debate information. The specific application scene of the method for generating debate information is shown as 4. The debate platform in FIG. 4 may receive the topic information input by a user. On the basis of the topic information, the debate information with mood enhancement characteristics of the debate stages is generated according to the debate time sequence based on a predetermined language model. Specifically, the process for generating the debate information according to the debate time sequence based on the predetermined language model is shown in FIG. 5. In FIG. 5, the viewpoints of both debate sides, the opening statements of both debate sides, the rebuttal speeches of both debate sides, the free debate content of both debate sides and the closing statements of both debate sides are generated according to the debate time sequence based on the predetermined language model on the basis of the topic information respectively. Furthermore, in order to enable the predetermined language model to generate the debate information with the mood enhancement characteristics, the prompt information of the debate stages may be extracted from the debate requirements corresponding to debate stages. The prompt information of the debate stages is taken as a mood expression control instruction. The prompt information and the topic information are input into the predetermined language model together. The debate information with the mood enhancement characteristics of the debate stages corresponding to the topic information is generated through the predetermined language model.

Specifically, on the basis of the inputted topic information, the viewpoints of both debate sides are firstly generated according to the debate time sequence based on the predetermined language model. It should be noted that, the viewpoints of both debate sides are generated synchronously after the topic information is input into the predetermined language model, and there is no order of priority. Accordingly, prompts for both debate sides may be set up in the following form.

Please separate the topic information into affirmative and negative topics for debate. Topic: “{Topic}”.

Height line:
1. Output only a topic without any details or explanations.
2. The output format is as follows:
Affirmative: xxx (with a limit of 20 words in length).
Negative: xxx (with a limit of 20 words in length).

Specifically, on the basis of the topic information and the viewpoints of both debate sides, opening statements of the both debate sides are generated according to the debate time sequence based on the predetermined language model. It should be noted that, the opening statements of the both debate sides are generated respectively after the topic information and the viewpoint of one debate side are input into the predetermined language model together, and there is no order of priority. That is, the opening statement of one debate side does not influence the opening statement of the other debate side. For the affirmative's opening statement, the topic information and the affirmative's debate viewpoint may be input into the predetermined language model together to generate the affirmative's opening statement. Correspondingly, the prompt information in the following form may be set for the affirmative's opening statement.

Please act as affirmative in debate. Topic: “{Topic}”.

Your position is affirmative.

Now, please make an opening statement as the affirmative.

Requirements:
1. The opening statement should illustrate your core viewpoint.
2. The word count should not exceed 100 words.

Similarly, for the negative's opening statement, the topic information and the negative's debate viewpoint may be input into the predetermined language model together to generate the negative's opening statement. Correspondingly, the prompt information in the following form may be set for the negative's opening statement.

Please act as negative in debate. Topic: “{Topic}”.

Your position is negative.

Now, please make an opening statement as the negative.

Requirements:
1. The opening statement should illustrate your core viewpoint.
2. The word count should not exceed 100 words.

Specifically, on the basis of the topic information, the viewpoints of both debate sides and opening statements of the both debate sides, the rebuttal speeches of the both debate sides are generated according to the debate time sequence based on the predetermined language model. It should be noted that, the rebuttal speeches of the both debate sides are generated respectively after the topic information, the viewpoint of one debate side and the opening statements of the both debate sides are input into the predetermined language model together, and there is no order of priority. That is, the rebuttal speech of one debate side does not influence the rebuttal speech of the other debate side. For the affirmative's rebuttal speech, the topic information, the affirmative's debate viewpoint and the opening statements of the both debate sides may be input into a predetermined language model together to generate the affirmative's rebuttal speech. Correspondingly, the prompt information in the following form may be set for the affirmative's rebuttal speech.

Please act as affirmative in debate. Topic: “{Topic}”.

Your position is affirmative.

Your opening statement is: {aff_opening}.

Now, please rebut the negative's opening statement as follows: {neg_opening}

Requirements:
1. Rebut the negative's opening statement specifically. Come to the point, no kidding.
2. The word count should not exceed 60 words.

Similarly, for the negative's rebuttal speech, the topic information, the negative's debate viewpoint and the opening statements of the both debate sides may be input into the predetermined language model together to generate the negative's rebuttal speech. Correspondingly, the prompt information in the following form may be set for the negative's rebuttal speech:

Please act as negative in debate. Topic: “{Topic}”.

Your position is negative.

Your opening statement is: {neg_opening}.

Now, please rebut the affirmative's opening statement as follows: {aff_opening}.

Requirements:
1. Rebut the affirmative's opening statement specifically. Come to the point, no kidding.
2. The word count should not exceed 60 words.

Specifically, on the basis of the topic information, the viewpoints of both debate sides, the opening statements of the both debate sides and the rebuttal speeches of the both debate sides, the free debate content of the both debate sides is generated according to the debate time sequence based on the predetermined language model. It should be noted that, the free debate content of the both debate sides is generated respectively after the topic information, the viewpoint of one debate side, the opening statements of the both debate sides and the rebuttal speeches of the both debate sides are input into the predetermined language model together. Since the free debate between the two debate sides is based on one side's statement to refute the other side's statement, it means that the free debate between the two debate sides has a sequence. That is, the free debate content of one debate side influences the free debate content of the other debate side. For the affirmative's free debate content, the topic information, the affirmative's debate viewpoint, the opening statements of the both debate sides and the rebuttal speeches of the both debate sides may be input into the predetermined language model together to generate the affirmative's free debate content. Correspondingly, the prompt information in the following form may be set for the affirmative's free debate content.

Please act as affirmative in debate. Topic: “{Topic}”.

Your position is affirmative.

In the last stage, the both sides make the following opening statements and rebuttal speeches respectively.

The affirmative's opening statement: {aff_Opening}.

The negative's opening statement: {neg_Opening}.

The affirmative's rebuttal: {aff_rebutal}.

The negative's rebuttal: {neg_rebutal}.

Now, as affirmative in debate, please deliver your first free debate speech. You can respond to the other side's arguments or make new viewpoints to strengthen your position.

Requirements:
1. Keep the speech concise and to the point.
2. The word count should not exceed 40 words.

Similarly, for the negative's free debate content, the topic information, the negative's debate viewpoint, the opening statements of the both debate sides, the rebuttal speeches of the both debate sides and the affirmative's free debate content may be input into the predetermined language model together to generate the negative's free debate content. Correspondingly, the prompt information in the following form may be set for the negative's free debate content.

Please act as negative in debate. Topic: “{Topic}”.

Your position is negative.

In the last stage, the both sides make the following opening statements and rebuttal speeches respectively.

The affirmative's opening statement: {aff_Opening}.

The negative's opening statement: {neg_Opening}.

The affirmative's rebuttal: {aff_rebutal}.

The negative's rebuttal: {neg_rebutal}.

The affirmative's free debate content: {aff_free1}.

Now, as negative in debate, please deliver your first free debate speech. You can respond to the other side's arguments or make new viewpoints to strengthen your position.

Requirements:
1. Keep the speech concise and to the point.
2. The word count should not exceed 40 words.

Specifically, on the basis of the topic information, the viewpoints of both debate sides, the opening statements of the both debate sides, the rebuttal speeches of the both debate sides and the free debate content of the both debate sides, the closing statements of the both debate sides are generated according to the debate time sequence based on the predetermined language model. It should be noted that, the closing statements of the both debate sides are generated respectively after the topic information, the viewpoint of one debate side, the opening statements of the both debate sides, the rebuttal speeches of the both debate sides and the free debate content of the both debate sides are input into the predetermined language model together. Since the closing statements of the both debate sides is based on one side's statement to refute the other side's statement, it means that the closing statements of the both debate sides have a sequence. That is, the closing statement of one debate side influences the closing statement of the other debate side. For the affirmative's closing statement, the topic information, the affirmative's debate viewpoint, the opening statements of the both debate sides, the rebuttal speeches of the both debate sides and the free debate content of the both debate sides may be input into the predetermined language model together to generate the affirmative's closing statement. Correspondingly, the prompt information in the following form may be set for the affirmative's closing statement.

Please act as affirmative in debate. Topic: “{Topic}”.

Your position is affirmative.

In the last stage, the both sides make the following opening statements and rebuttal speeches respectively.

The affirmative's opening statement: {aff_Opening}.

The negative's opening statement: {neg_Opening}.

The affirmative's rebuttal: {aff_rebutal}.

The negative's rebuttal: {neg_rebutal}.

The affirmative's free debate content: {aff_free1}.

The negative's free debate content: {neg_free1}.

Now, as affirmative in debate, please show the affirmation in the closing statement. You need to first refute the negative aspects of the core argument, then emphasize the core argument and prove your own viewpoints.

Requirements:
1. Keep the speech concise and to the point.
2. The word count should not exceed 50 words.

Similarly, for the negative's closing statement, the topic information, the negative's debate viewpoint, the opening statements of the both debate sides, the rebuttal speeches of the both debate sides, the free debate content of the both debate sides and the affirmative's closing statement may be input into the predetermined language model together to generate the negative's closing statement. Correspondingly, the prompt information in the following form may be set for the negative's closing statement.

Please act as negative in debate. Topic: “{Topic}”.

Your position is negative.

In the last stage, the both sides make the following opening statements and rebuttal speeches respectively.

The affirmative's opening statement: {aff_Opening}.

The negative's opening statement: {neg_Opening}.

The affirmative's rebuttal: {aff_rebutal}.

The negative's rebuttal: {neg_rebutal}.

The affirmative's free debate content: {aff_free1}.

The negative's free debate content: {neg_free1}.

The affirmative's closing statement: {aff_Closing}.

Now, as negative in debate, please show negation in the closing statement. You need to first refute the affirmative aspects of the core argument, then emphasize the core argument and prove your own viewpoints.
1. Keep the speech concise and to the point.
2. The word count should not exceed 50 words.

In application scenarios, the basic language model relies heavily on statistically generated statements to automatically generate debate viewpoints based on the topic information. The basic language model lacks a deep understanding of debate logic, philosophy or other disciplines, and may rapidly generate a large amount of contents, but still has defects in deep logic reasoning and complex opening statement, especially in the case of crossing knowledge fields or rigorous argumentation. This results in a less coherent or logical viewpoint of the debate of the output by the basic language model, resulting in a less authentic or deeper experience. As an improvement of the predetermined language model, a special logical reasoning algorithm, such as symbolic reasoning or a rule-based system, may be integrated in the predetermined language model of the embodiment to assist the predetermined language model to better understand and construct a complex debate structure with the logical reasoning algorithm, so that the reasoning module can capture causal relationships, logical connections, and the like in the debate information better by adding the reasoning module in the basic language model. As another improvement of the predetermined language model, more high-quality debate data may be introduced into the predetermined language model of the embodiment, especially debate data in the strict demonstration field, such as philosophy, law, and the like. The capability of the predetermined language model to generate deep arguments is improved through the high-quality debate data.

In application scenarios, although the basic language model may generate proper debate information according to the topic information input currently, in a long-time debate process, the basic language model has certain memory limitation when processing context. The length of a corresponding context window is limited within a specific word count, and the previous debate information will lose when exceeded, so that the basic language model is difficult to remember the previous arguments and discussion contents, and easily produces repetitive or contradictory debate information, preventing the basic language model from effectively tracking context in longer debate scenes, leading to a decrease in the continuity and consistency of the debate, and affecting the overall interactive experience. As an improvement of the predetermined language model, a long-short memory module and a class persistence module may be introduced into the predetermined language model of the embodiment to ensure that the predetermined language model can retain and recall the previous contents at each debate stage, thereby improving the continuity of debate information. As another improvement of the predetermined language model, the core arguments in the debate may be summarized in real time. By generating core argument summaries of the core arguments at regular intervals, it allows the predetermined language model of the embodiment to be able to revisit previous discussions at the debate stages based on the core argument summaries, ensuring consistency in the context of the debate information. As another improvement of the predetermined language model, a special multi-round conversation model is constructed for a long-time debate scene, so that a long sequence is effectively processed through the combination of the multi-round conversation model and the predetermined language model, and a memory bank is established in different rounds, so that the fluency of the user in long-time debate is improved.

In application scenarios, due to the difficulty of the basic language model to accurately simulate complex emotional changes and subtle interpersonal communication skills, and the lack of emotion recognition and appropriate feedback mechanisms in expression, automatically generated debate information based on the topic information usually lack emotional tension, which makes the interactive process of the debate scenarios more mechanized. As an improvement of the predetermined language model, the emotion generation technology may be used for adjusting the tone and the response manner of the debate information on the basis of outputting the debate information by the predetermined language model, so that the debate interaction process is more real and vivid. As another improvement of the predetermined language model, a plurality of debate style modules may be designed in the predetermined language model of the embodiment. Different debate characters or tone styles (such as strong debaters, mild debaters) are simulated by the different debate style modules, so that the debater may select a favorite style to improve the interaction experience. As another improvement of the predetermined language model, the predetermined language model of the embodiment is combined with the scene modeling. The predetermined language model after the scene modeling is used to understand social hints and non-explicit information in the conversation, so as to improve the interaction skills of the predetermined language model in the debate process.

In application scenarios, personalized restrictions need to be accumulated based on user figures and long-term interaction data, and the basic language model cannot effectively customize the debate styles and requirements of different users. Considering that different users have different debate styles and interest points, the basic language model cannot be dynamically adjusted, leading to a poor debate interaction experience. As an improvement of the predetermined language model, the personalized user figures may be generated for each user by analyzing the historical debate data of the user. The predetermined language model in the embodiment is trained based on the personalized user figures, so that the trained predetermined language model can generate customized debate information based on the debate styles, interest points and knowledge levels of different users. As another improvement of the predetermined language model, the debate parameters of the predetermined language model in the embodiment may be adjusted. The debate parameters include one or more of the following: debate depth, debate tone, debate speed and debate emotion expression. The predetermined language model after parameter adjustment may better adapt to the personal requirements of the user. As another improvement of the predetermined language model, a user feedback closed loop is established by collecting feedback evaluation of the user, and by continuously adjusting and optimizing the performance of the predetermined language model in the embodiment according to the feedback evaluation of the user, so that the user feedback closed loop helps the system to better understand user requirements and automatically perform personalized optimization.

In application scenarios, a basic language model is usually trained based on historical debate data. Latest debate information is difficult to acquire in real time. Especially for debate scenes that require high timeliness, the basic language model usually has hysteresis, and the corresponding debate information cannot be updated rapidly, particularly in the debate related to current affairs or latest research, which makes it difficult for the basic language model to give accurate debate information when the debate scenes are related to current affairs or emerging topics, and reduces the reference value of the debate information. As an improvement of the predetermined language model, the latest debate information may be acquired by accessing a real-time knowledge bank or an internet search function to adjust the predetermined language model in the embodiment with the latest debate information, thereby ensuring that the debate information generated by the predetermined language model can be applied to the latest current event data. As another improvement of the predetermined language model, a continuous learning capability may be added to the predetermined language model in the embodiment. The knowledge base is quickly updated through an incremental learning mechanism when the latest debate information appears, so as to continuously improve the knowledge base to which the predetermined language model is docked. As another improvement of the predetermined language model, in the case that the debate information needs to be updated, the predetermined language model in the embodiment is connected to an external database, for example, a news database, a latest academic library, etc., through an interface, so as to supplement the updated content of the debate information with the external data.

In application scenarios, the basic language model has limited comprehension ability and reasoning ability to complex concepts, and is easy to lack of deep viewpoints. For sensitive topics related to philosophy, theory and the like, the debate information output by the basic language model is usually superficial and cannot deeply mine complexity and multi-angle in the debate information, so that the user may feel that the debate information is only at the conventional common points of discussion when debate the complex topics, and cannot provide novelty or deep insights. As an improvement of the predetermined language model, the predetermined language model of the embodiment may be fine-tuned by using specific field data according to different complex topics. A plurality of field expert sub-models are constructed. The associated field expert sub-models are dynamically called during debate to provide deep demonstration. As another improvement of the predetermined language model, a multi-model cooperation structure may be designed. The predetermined language model in the embodiment may integrate knowledge in multiple fields to provide more comprehensive debt information under complex topics through cooperative work of models in different fields in the debate process. As another improvement of the predetermined language model, logic programming or a special inference engine may be combined. The logic programming and the special inference engine are used as drivers, so that the predetermined language model in the embodiment can construct a tighter inference chain in the debate process of complex topics, thereby effectively generating dispute information.

In application scenarios, since the training data may include bias, the basic language model may generate the debate information with implicit bias or round that does not meet the moral specification. Although the filtering mechanism has been used to reduce the possibility that the output of the basic language model has the bias debate information, the basic language model still cannot completely avoid learning the invisible bias from the training data in the training process, so that the basic language model generates the debate information with bias content in the aspects of gender discrimination, race and the like, which not only destroys the user experience, but also causes discomfort and dispute to the debate information. As an improvement of the predetermined language model, a bias detection module may be introduced in the process for generating the debate information by the predetermined language model in the embodiment. The bias detection module uses a special algorithm to review the generated debate information to filter out potential bias content. As another improvement of the predetermined language model, diversified training data may be constructed. The training data cover different cultures, sexes, ethnicities, backgrounds and the like. The predetermined language model in the embodiment is trained through the diversified training data, so that the possibility of absorbing bias in the training process is reduced. As another improvement of the predetermined language model, before the predetermined language model in the embodiment generates the debate information, an ethical review mechanism may be added to detect whether there is a moral problem in the debate information, and automatically adjust or correct the debate information.

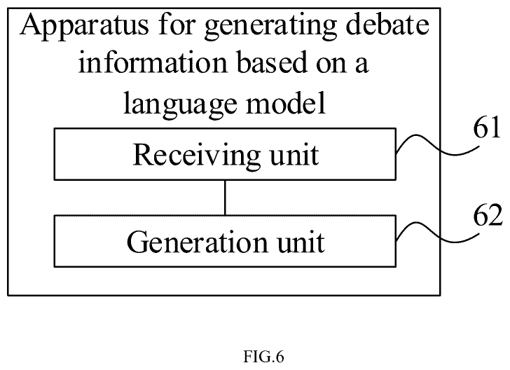

Further, as a specific implementation of the method shown in FIG. 1-5, an apparatus for generating debate information based on a language model is provided according to an embodiment of the present disclosure. As shown in FIG. 6, the apparatus includes a receiving unit 61 and a generation unit 62.

The receiving unit 61 is configured to receive an operation instruction for generating debate information of a user, wherein the operation instruction carries topic information input by the user, and wherein the type of the topic information comprises any one or more of the following: text, audio and picture.

The generation unit 62 is configured to generate the debate information with mood enhancement characteristics of debate stages corresponding to the topic information based on a predetermined language model and the topic information.

An apparatus for generating debate information based on a language model is provided according to the present disclosure. In the present disclosure. In comparison with the method for generating the debate information based on a large language model in the prior art, an operation instruction for generating debate information of a user is received. The debate information with mood enhancement characteristics of debate stages corresponding to the topic information is generated based on a predetermined language model and the topic information carried by the operation instruction and input by the user. Here, the type of the topic information includes any one or more of the following: text, audio and picture. The mood expression capability of the debate information is enhanced through the predetermined language model in the whole process, so that the output debate information has mood enhancement characteristics of the debate stages in expression, more emotions are given to the debate information to a certain extent, and the mood tension of the debate information in a real debate scene is further improved.

In application scenarios, the predetermined language model is a language model after a mood enhancement adjustment.

In application scenarios, the mood enhancement adjustment is a mood enhancement adjustment by a prompt and/or a mood enhancement adjustment by a model fine-tuning.

In application scenarios, the debate stages comprise any one or more of the following: an opening statement stage, a rebuttal speech stage, a free debate stage and a closing statement stage.

In application scenarios, the debate stages correspond to different mood enhancement characteristics. The correspondence between the mood enhancement characteristics of the debate stages comprises one or more of the following characteristics: tone, manner, expression manner, reference and logical structure.

In application scenarios, the correspondence between the mood enhancement characteristics of the debate stages comprises any one or more of the following:
the opening statement stage corresponds to a first mood enhancement characteristic, and correspondingly, the debate information corresponding to the topic information comprises one or more of the following characteristics: clear debate viewpoint, clear logical relationship and self-confident tone;
the rebuttal speech stage corresponds to a second mood enhancement characteristic, and correspondingly, the debate information corresponding to the topic information comprises any one or more of the following characteristics: a strong tone and a set mood expression manner, wherein the mood expression manner comprises any one or more of the following: parallelism, contrast and rhetorical questions;
the free debate stage corresponds to a third mood enhancement characteristic, and correspondingly, the debate information corresponding to the topic information comprises a set speech expression manner, wherein the speech expression manner comprises a lifelike example manner and/or a spoken language expression manner; and
the closing statement stage corresponds to a fourth mood enhancement characteristic, and correspondingly, the debate information corresponding to the topic information comprises a reference characteristic of a set field, wherein the reference characteristic comprises text cite and/or key data reference, and the set field is a field associated with the topic information.

In application scenarios, the debate information comprises any one or more of the following: text, speech, video, picture, virtual object with real-time interaction function.

In application scenarios, the virtual object with a real-time interaction function is generated based on a language model with multi-mode characteristics. The debate information output by the virtual object with a real-time interaction function shows mood enhancement characteristics at the debate stages.

In application scenarios, the debate information comprises a virtual object with a real-time interaction function, and specifically, the debate information corresponding to the topic information is presented through the virtual object with a real-time interaction function, wherein the debate information is generated based on the predetermined language model and the topic information, and comprises the mood enhancement characteristics of the debate stages.

In application scenarios, the apparatus further includes an acquiring unit, a constructing unit and a fine-tuning unit.

The acquiring unit is configured to, before the receiving an operation instruction for generating debate information of a user, acquire sample information of a debate scene. The sample information includes topic sample information and debate sample information of the debate stages corresponding to the topic sample information.

The constructing unit is configured to construct a mood instruction for enhancing mood expression capability of the model in a debate process according to mood labels of the debate stages.

The fine-tuning unit is configured to perform model fine-tuning on a basic language model by using the mood instruction and the sample information to generate the predetermined language model.

In application scenarios, the apparatus further includes a recognition unit and an association unit.

The recognition unit is configured to, after the acquiring sample information of a debate scene, perform mood recognition on the debate sample information of the debate stages based on a predetermined mood recognition model to acquire mood characteristics contained in the debate sample information.

The association unit is configured to associate the debate sample information of the debate stages with the mood characteristics contained in the corresponding debate sample information to acquire the mood characteristics corresponding to the debate stages.

It should be noted that other corresponding descriptions of the functional units related to the apparatus for generating debate information based on a language model provided in the embodiment may refer to the corresponding descriptions in FIG. 1 to FIG. 5, and are not repeated herein.

Based on the method shown in FIG. 1 to FIG. 5, correspondingly, a storage medium is further provided according to an embodiment of the present disclosure. The storage medium stores a computer program. The program, when executed by a processor, performs the method for generating debate information based on a language model shown in FIG. 1 to FIG. 6.

Based on such understanding, the technical solutions of the present disclosure may be implemented in a form of a software product. The software product may be stored in a non-volatile storage medium (which may be a CD-ROM, a USB flash drive, a removable hard disk, or the like), including several instructions for instructing a computing device (which may be a personal computer, a server, a network device, or the like) to perform the methods according to the embodiments of the present disclosure.

Based on the method shown in FIG. 1 to FIG. 5 and the virtual device embodiment shown in FIG. 6, to achieve the above objectives, an entity device for generating debate information based on a language model is further provided according to an embodiment of the present disclosure. The entity device may be specifically a computer, a smart phone, a tablet computer, a smart watch, a server, a network device, or the like. The entity device includes a storage medium and a processor. The storage medium is configured to store a computer program. The processor is configured to execute the computer program to implement the method for generating debate information based on a language model as shown in FIG. 1 to FIG. 5.

Optionally, the entity device may further include a user interface, a network interface, a camera, a radio frequency (RF) circuit, a sensor, an audio circuit, a WI-FI module, and the like. The user interface may include a display, an input unit such as a keyboard, and the like. Optionally, the user interface may further include a USB interface, a card reader interface, and the like. Optionally, the network interface may include a standard wired interface, a wireless interface (such as a WI-FI interface), and the like.

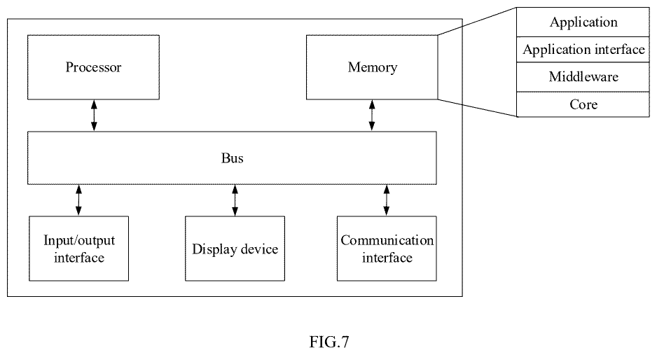

In an exemplary embodiment, referring to FIG. 7, the entity device includes a communications bus, a processor, a memory and a communications interface. The entity device may further include an input/output interface and a display device. The functional units may communicate with each other via the bus. The memory stores a computer program. The processor is configured to execute the program stored in the memory to perform the method for generating debate information based on a language model in the above embodiments.

Those skilled in the art can understand that the entity device structure for generating debate information based on a language model provided according to the embodiment does not constitute a limitation to the entity device. The entity device may comprise more or fewer components, may comprise a combination of a part of the components, or may comprise the components arranged in a different manner.

The storage medium may also include an operating system and a network communication module. The operating system is a program that manages the hardware and software resources of the physical device for generating debate information based on a language model. The operating system supports the execution of the information processing program and other software and/or programs. The network communication module is configured to realize communication among components in the storage medium and other hardware and software in the information processing entity device.

As can be seen from the above description of the embodiments, those skilled in the art can clearly understand that the present disclosure can be implemented by software plus a necessary general hardware platform or implemented by hardware. With the technical solutions of the present disclosure, in comparison with the prior art, the mood expression capability of the debate information is enhanced through the predetermined language model, so that the output debate information has mood enhancement characteristics of the debate stages in expression, more emotions are given to the debate information to a certain extent, and the mood tension of the debate information in a real debate scene is further improved.

Those skilled in the art will appreciate that the drawings are merely schematic representations of preferred embodiments and that the modules or workflows are not necessary to implement the present disclosure. Those skilled in the art may understand that the modules in the device of the implementation may be distributed in the device of the implementation according to the implementation description, and may also be located in one or more devices different from the present implementation with corresponding changes. The modules of the implementation may be combined into one module, or may be further split into multiple sub-modules.

The sequence numbers of the foregoing embodiments of the present disclosure are merely for description purpose, and do not indicate the preference among the embodiments. The above disclosure is only for a few concrete implementation scenarios of the present disclosure, however, the present disclosure is not limited thereto. Any changes made by those skilled in the art fall into the protection scope of the present disclosure.

What is claimed is:

1. A method for generating debate information based on a language model, comprising:
receiving an operation instruction for generating debate information of a user, wherein the operation instruction carries topic information input by the user, and wherein the type of the topic information comprises any one or more of the following: text, audio and picture; and
generating the debate information with mood enhancement characteristics of debate stages corresponding to the topic information based on a predetermined language model and the topic information.

2. The method according to claim 1, wherein the predetermined language model is a language model after a mood enhancement adjustment.

3. The method according to claim 2, wherein the mood enhancement adjustment is a mood enhancement adjustment by a prompt and/or a mood enhancement adjustment by a model fine-tuning.

4. The method according to claim 1, wherein the debate stages comprise any one or more of the following: an opening statement stage, a rebuttal speech stage, a free debate stage and a closing statement stage.

5. The method according to claim 4, wherein the debate stages correspond to different mood enhancement characteristics, and wherein the correspondence between the mood enhancement characteristics of the debate stages comprises one or more of the following characteristics: tone, manner, expression manner, reference and logical structure.

6. The method according to claim 5, wherein the correspondence between the mood enhancement characteristics of the debate stages comprises any one or more of the following:
the opening statement stage corresponds to a first mood enhancement characteristic, and correspondingly, the debate information corresponding to the topic information comprises one or more of the following characteristics: clear debate viewpoint, clear logical relationship and self-confident tone;
the rebuttal speech stage corresponds to a second mood enhancement characteristic, and correspondingly, the debate information corresponding to the topic information comprises any one or more of the following characteristics: a strong tone and a set mood expression manner, wherein the mood expression manner comprises any one or more of the following: parallelism, contrast and rhetorical questions;
the free debate stage corresponds to a third mood enhancement characteristic, and correspondingly, the debate information corresponding to the topic information comprises a set speech expression manner, wherein the speech expression manner comprises a lifelike example manner and/or a spoken language expression manner; and
the closing statement stage corresponds to a fourth mood enhancement characteristic, and correspondingly, the debate information corresponding to the topic information comprises a reference characteristic of a set field, wherein the reference characteristic comprises text cite and/or key data reference, and the set field is a field associated with the topic information.

7. The method according to claim 1, wherein the debate information comprises any one or more of the following: text, speech, video, picture, virtual object with a real-time interaction function.

8. The method according to claim 1, wherein the debate information comprises a virtual object with a real-time interaction function, and specifically, the debate information corresponding to the topic information is presented through the virtual object with a real-time interaction function, wherein the debate information is generated based on the predetermined language model and the topic information, and comprises the mood enhancement characteristics of the debate stages.

9. The method according to claim 1, wherein before the receiving an operation instruction for generating debate information of a user, the method further comprises:
acquiring sample information of a debate scene, wherein the sample information comprises topic sample information and debate sample information of the debate stages corresponding to the topic sample information;
constructing a mood instruction for enhancing mood expression capability of the model in a debate process according to mood labels of the debate stages; and
performing model fine-tuning on a basic language model by using the mood instruction and the sample information to generate the predetermined language model.

10. The method according to claim 9, wherein after the acquiring sample information of a debate scene, the method further comprises:
performing mood recognition on the debate sample information of the debate stages based on a predetermined mood recognition model to acquire mood characteristics contained in the debate sample information; and
associating the debate sample information of the debate stages with the mood characteristics contained in the corresponding debate sample information to acquire the mood characteristics corresponding to the debate stages.

11. An apparatus for generating debate information based on a language model, comprising:
a receiving unit configured to receive an operation instruction for generating debate information of a user, wherein the operation instruction carries topic information input by the user, and wherein the type of the topic information comprises any one or more of the following: text, audio and picture; and
a generation unit configured to generate the debate information with mood enhancement characteristics of debate stages corresponding to the topic information based on a predetermined language model and the topic information.

12. A computer device comprising: a memory storing a computer program; and a processor, wherein the processor, when executing the computer program, performs the method for generating debate information based on a language model according to claim 1.

13. A computer-readable storage medium storing a computer program, wherein the computer program, when executed by a processor, performs the method for generating debate information based on a language model according to claim 1.
